(19) United States
(12) Patent Application Publication
(10) Pub. No.: US 2017/0274332 A1
(43) Pub. Date: Sep. 28, 2017

(54) PROTEIN BLENDER CUP

(71) Applicant: Ashish GANDHI, Buena Park, CA (US)

(72) Inventor: Ashish GANDHI, Buena Park, CA (US)

(21) Appl. No.: 15/406,765

(22) Filed: Jan. 15, 2017

Related U.S. Application Data
(60) Provisional application No. 62/313,794, filed on Mar. 27, 2016.

(51) Int. Cl. B01F 7/00; B01F 15/00; B01F 7/30; B01F 3/12; B01F 7/20

(52) U.S. Cl. CPC B01F 7/00991; B01F 3/1221; B01F 7/0025; B01F 7/00641; B01F 7/20; B01F 7/305; B01F 15/00668; B01F 7/002; B01F 15/00506; B01F 2215/0022

(57) ABSTRACT

Present invention creatively makes convenient for any person using beverage to blend powder with liquid uniformly without use of shaking motion or battery and thereby preventing from spilling and running out batteries. Invention of unique reverse planetary gears system and side arm stirrer with window paddle has made possible convert torque of finger to multiple rotation of stirrer in order achieve efficient uniform blending. Moreover, this invention takes full advantage of removable snap mechanism to assemble and disassemble protein blender cup which is very necessary for washing every single parts to achieve highest sanitization. In short, this invention helps consumer to have protein blender cup which doesn't require shaking or battery and can be completely sanitized without any struggle.

### FIELD OF THE INVENTION

The present invention relates generally to a liquid storage receptacle. More specifically, the present invention is a cup with an integrated blender system that is manually operated to blend contents within the cup. The present invention is quickly and conveniently disassembled for cleaning after using through snap mechanism.

### BACKGROUND OF THE INVENTION

Nutritional supplements are commonly utilized by people before, during, and after strenuous workouts. Nutritional supplements such as whey protein are commonly found in the form of powdered products, which are mixed with liquids to create nutritional beverages. Without proper stirring, the powder tends to clump together and float in chunks within the liquid. Blender cups that are presently available on the market generally require batteries or manual shaking of the contents. There are several drawbacks to the currently available products. Battery-operated electronic blender cups are expensive and it is often quite difficult to replace the batteries. Blender cups that require manual shaking are subject to the contents within the cups leaking or spilling. The present invention seeks to address the inherent issues found in current prior art.

It is therefore the object of the present invention to improve upon the current prior art. The present invention is a cup with an integrated blender system that is manually operated to stir contents within the cup. The lid of the blender cup features an oval handle fused to a freely rotating ring gear that is held in between top and bottom cap through snap mechanism. Rotating ring gear projects teeth inside. The oval turn handle is manually operated to rotate the ring gear which rotates planetary gears and thereby sun gear which are suspended on bottom cap through shafts and central housing respectively. Stirrer is snapped into the sun gear. The interaction between the gear systems generates a compound ratio for the stirrer so rotation of ring gears by one time will result in multiple rotation of stirrer and there by stirring content within cup evenly. The stirrer has multiple side arms and a square window shaped paddle at bottom. The stirrer is removable from the cup and may be replaced by alternative devices such as a frother, ribbon shaped stirrer or stirrer with sharp steel blades. The present invention is designed in a manner such that the blender cup may be quickly disassembled for cleaning or swapping individual components of the cup by taking advantage of removable snap mechanism.

### BRIEF DESCRIPTION OF THE DRAWINGS

FIG. 1 is a the complete breakdown of every single part of present invention

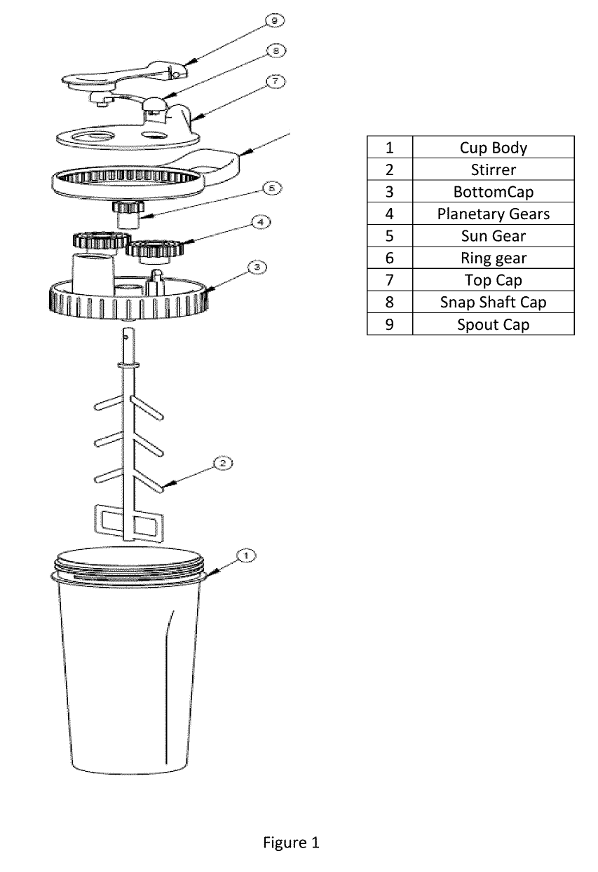

FIG. 2 is the front view of present invention

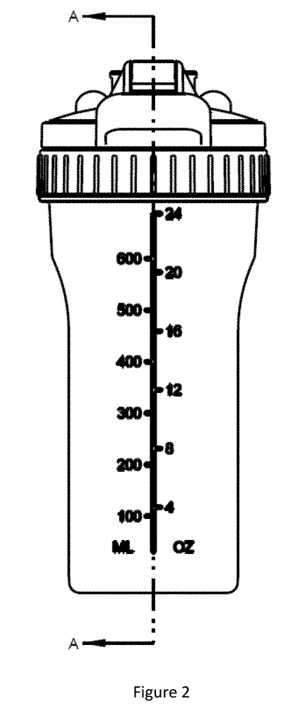

FIG. 3 is cross sectional view of blender cup which shows internal mechanism of cap and stirrer

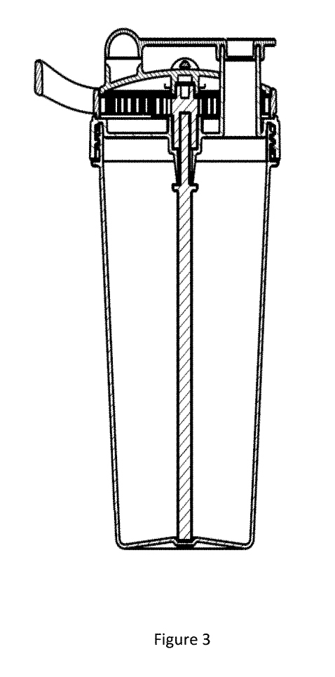

FIG. 4 is a drawing of bottom of the cup with circular depression and complete cup body with side depression and marking of gm./ml

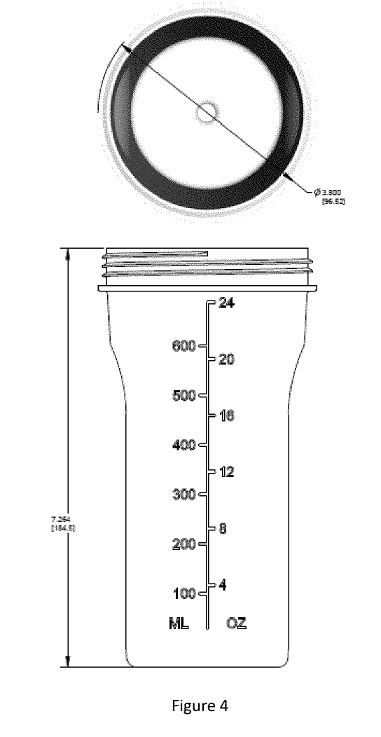

FIG. 5 is a cross-sectional view of snap shaft cap which shows two domes attached with plastic cane

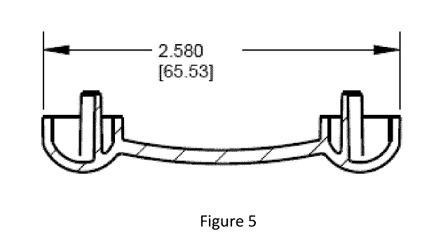

FIG. 6 is the front view of top cap which shows two circular openings for snap shafts of bottom cap and also opening for spout

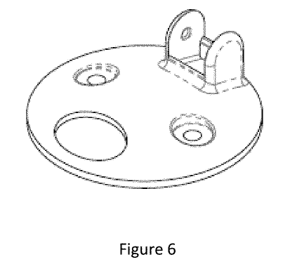

FIG. 7 is the side view of spout cap which shows dome and ring surrounded to it

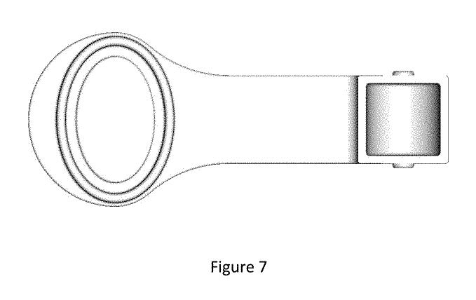

FIG. 8 is the top view of ring gear fused with oval handle which shows several teeth projecting inside and oval turn handle

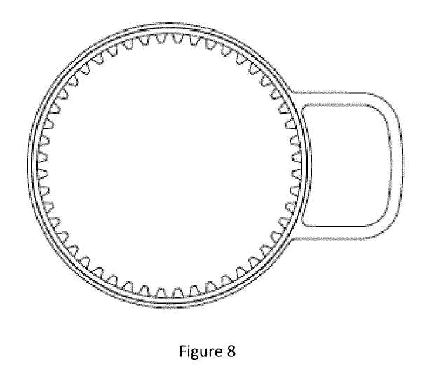

FIG. 9 is the top view of bottom cap which shows two snap shaft housing for sun gear, spout tube, central circular housing and surrounding ridges for better grip

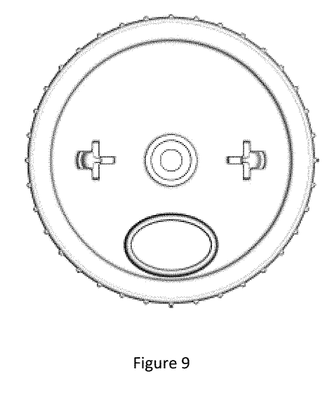

FIG. 10 is the side view of planetary gear showing teeth and shaft

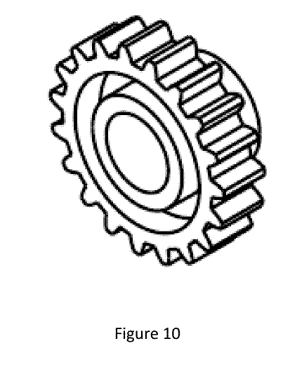

FIG. 11 is cross-section view of sun gear which shows square housing at bottom shaft and cylindrical projection on top which stays in circular housing of top cap to keep stirrer in central position

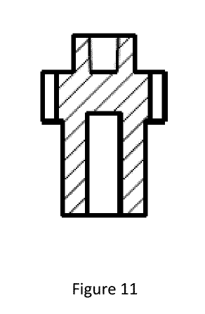

FIG. 12 is the side view of stirrer with side arms and window shaped paddle at bottom

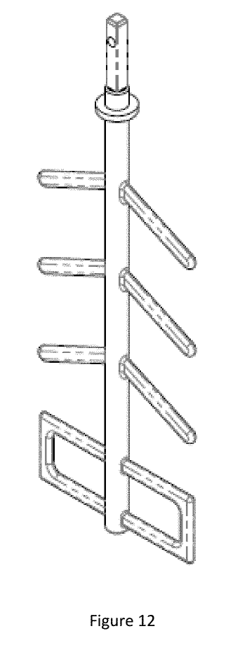

### DETAIL DESCRIPTIONS OF THE INVENTION

All illustrations of the drawings are for the purpose of describing selected versions of the present invention and are not intended to limit the scope of the present invention. The present invention is a cup that contains an integrated blender system within the cup. In its preferred embodiment, the present invention comprises a lid, cup body and stirrer. Lid holds blending mechanism which comprise of snap shaft cap, top cap, bottom cap, a ring gear with fused oval handle on outer surface, two planetary gears and one sun gear. The present invention may be quickly disassembled into its individual components for cleaning or swapping of the components.

The diameter of the first end of the cup is larger than that of the second end of the cup. Top end of cup body has threading which corresponds to threading of lip of bottom cap of lid. Cup body can be easily screwed into lid. Moreover, this treading is designed in such a way that it can provide better protection from leaking while blending. The tapered cylindrical extrusion of material is hollow with the first end of the cup open to the exterior and the second end of the cup closed. At the bottom of cup there is a small circular depression which provided housing for bottom end of stirrer. This housing is designed to keep stirrer in the center while rotating.

The lid comprises of five main parts snap shaft cap, top cap, spout cap, bottom cap with gears and freely moving ring gear with fused oval handle at outer surface.

Snap Shaft cap is made of two dome shaped cap which is fused through a plastic cane. The main purpose of this snap shaft cap is to hid snap mechanism and prevent powder or liquid to pour into shafts of bottom cap. The dome present at each end of snap shaft cap fills the space left over by snap shaft of bottom cap. The Snap shaft cap is essentially another snap mechanism that provides more support to snap mechanism between top and bottom cap.

Top cap is very carefully designed dome which snaps onto shafts of bottom cap and sits on ring gear without providing much resistance. Top cap has three opening, two circular openings correspond to shafts of bottom cap and one oval opening on the side which provides spout to go through. In the center of the interior side of the top cap has circular housing which provides housing for the top end of sun gear. Top cap outer surface has a collar with two walls facing opposite site to hold spout cap. One end of spout cap is designed in such a way that it snaps in between two walls on the surface of top cap which is supported by collars on the side. This provides free movement to spout cap. On another end of spout cap has circular dome same size as spout opening. This dome snaps into spout opening and prevents liquid from leaking. In order to provide more protection from leaking dome is also covered with protective circular ring which sits on outer surface of spout opening while dome snapped in spout opening.

Lid also comprise of ring gear fused with oval handle. This ring gear has teeth projected inwards and remains engaged with teeth of planetary gears of bottom cap. Oval handle is fused to outer surface in such way that it provides maximum torque to planet gears. Oval handle has enough space as it can be operated by hand or index finger. Bottom cap has two snap shafts and central housing for sun gear. Shafts are designed in a way that it snaps in and out comfortably to top cap without providing much resistance to ring gear in the middle. Planetary gears comprises a tapered cylindrical extrusion of material with a plurality of ridges forming gear teeth along the outer surface of the gear and cylindrical shaft at bottom. The planetary gears are designed in a manner such that it rotates freely on solid snap shafts and remains engaged with sun gear and ring gear.

Sun gear comprises a tapered cylindrical extrusion of material with a plurality of ridges forming gear teeth along the outer surface of the gear, cylindrical shaft at bottom and lesser diameter cylindrical shaft on top. Top shaft of sun gear remains in position while freely rotating on base of bottom cap of housing using circular housing of a top cap. Sun gear shaft is hollow and has a square housing which is designed attach top end of stirrer. Thereby when stirrer is attached to sun gear through square housing; it converts 1 rotation of outer ring gear to five rotation of stirrer through compound ratio.

The present invention further comprises a stirrer device. In the preferred embodiment of the present invention, the Stirrer device consist of three side arms parallel to each other fused on a central shaft and window shaped paddle at bottom. the side arms creates a vortex and mixes liquid with powder while window paddle at bottom scoops up the powder in upward direction without allowing powder to form lump. This way the powder is distributed thoroughly at same time lumps are broken and blended smoothly. The stirrer device is held in place within the cup by snapping in one end in sun gear and another end resting in bottom housing of cup. Overall, this uniquely designed stirrer scoops up the powder from bottom and mixes powder in strong liquid vortex. However, the present invention is not limited with respect to shape and size of the stirrer device and alternative embodiments of the present invention may feature varying designs

Before using the present invention, nutritional supplements are placed into the cup along with the base liquid to be consumed. Stirrer is attached or screwed into sun gear of lid, placing the stirrer in contacts with sun gears. The lid is then screwed into the cup body. Rotating ring gear by oval handle using finger rotates the ring gear and causes the planet gears to rotate sun gear. As sun gear is far smaller it rotates faster than ring gears and planet gears. The rotation of the ring gear causes the planet gears to rotate and thereby causing rotation of sun gears and stirrer device. As the stirrer device rotates, the contents within the cup are stirred and mixed together. The user may continue rotating ring gears until he or she is satisfied with the nutritional beverage. To remove or replace the stirrer device, a user is only required to unscrew the lid.

In case of assembly, planetary gears are placed over shafts and sun gear placed in central housing of bottom cap. Ring gears is placed on the top of bottom cap and top cap is simply snapped on bottom cap. The domes of snap shaft cap is pressed onto top end of snap shafts. Once lid is ready stirrer is simply snapped in and lid is screwed into cup body.

In order to do major cleaning of blender cup; lid required to be unscrewed and stirrer needs to snap out. Snap shaft cap needs to be pulled out using leverage through plastic cane which exposes top end of snap shafts of bottom caps. As pressure is applied to snap shafts at same time using fingers and providing upward leverage through oval handle. It is detaches top cap from bottom cap. Now consumer can simply throw parts into dishwasher for cleaning or can use brush to clean if require. Total assembly or disassembly requires less than a minute.

An alternative embodiment of the present invention features a frother device in place of the stirrer device. The frother device is operated in the same manner as that of the blender device.

Although the present invention has been explained in relation to its preferred embodiment, it is to be understood that many other possible modifications and variations can be made without departing from the spirit and scope of the present invention.

1. A Protein blender Cup which blends powders with liquids without manual shaking or electric supply, comprising:
(a) A lid which houses reverse planetary gear system through removable snap mechanism that produces compound ratio for gears and thereby for stirrer by using one ring gear fused with oval turn handle, two planetary gears and one sun gear.
(b) And a uniquely designed stirrer which snaps into sun gear; it is made of three side arms fused to central shaft parallel to each other and a window paddles at bottom
(c) means for coupling torque from finger or hand to rotational energy of stirrer Whereby said a protein blender cup that blends powders to liquids without using shaking or electric supply
